(19) United States
(12) Patent Application Publication
(10) Pub. No.: US 2003/0219014 A1
(43) Pub. Date: Nov. 27, 2003

(54) Communication quality assuring method for use in packet communication system, and packet communication apparatus with transfer delay assurance function

(76) Inventors: Shigeru Kotabe, Fukuoka (JP); Yushi Murata, Fukuoka (JP); Katsumi Imamura, Fukuoka (JP); Takeshi Miyaura, Fukuoka (JP); Hideyo Fukunaga, Fukuoka (JP); Mitsukuni Yoshida, Fukuoka (JP)

Correspondence Address: KATTEN MUCHIN ZAVIS ROSENMAN, 575 MADISON AVENUE, NEW YORK, NY, 10022-2585, US

(21) Appl. No.: 10/323,289

(22) Filed: Dec. 19, 2002

(30) Foreign Application Priority Data
May 22, 2002 (JP) 2002-147484

(51) Int. Cl. H04L 12/50

(52) U.S. Cl. 370/375; 370/389

(57) ABSTRACT

A packet communication apparatus using a timer for always completing the transmission of a received packet within a delay assurance time length assurable by itself. The packet communication apparatus notifies information on the delay assurance time length to a destination side packet communication apparatus, while the destination side packet communication apparatus determines a received packet buffering quantity in communication with the origination side packet communication apparatus on the basis of the information notified. This optimizes a received packet buffering quantity in the destination side packet communication apparatus in a packet communication system, thus enabling the assurance of a necessary communication quality at a low cost.

### BACKGROUND OF THE INVENTION

(1) Field of the Invention

The present invention relates to a packet communication apparatus made to conduct data transmission through the use of, for example, an internet protocol or the like, and more particularly to a communication quality assuring method for use in a packet communication system and packet communication apparatus with a transfer delay assurance function, suitable for the assurance of quality of communication service (QoS) requiring real-time processing.

(2) Description of the Related Art

In general, in IP (Internet Protocol) networks, data (packets or cells) transmission is handled as the so-called best effort, and the assurance is not given to communication quality (QoS). However, in recent years, greater requirements for services requiring QoS have been imposed on the IP networks, and applications therefor have been developed very actively.

As examples of applications, there are real-time communications such as voice call using telephone and video (moving image) delivery, real-time communications for robot remote manipulation, remote medical treatment, and others. In the case of such applications, when data lacks, or in a case in which data arrives at a destination side after the elapse of an assumed maximum delay time (period or length of time), even if it occurs on only one packet, call quality or regenerative quality is greatly affected thereby, thus leading to the degradation of quality.

For this reason, on the assumption of the worst case of transfer delay of data and fluctuation thereof, for avoiding the failure of application operations even if data arrives after the maximum delay, the destination side (called side) such as a terminal buffers the incoming application data by a quantity corresponding to the maximum delay.

However, since the communication quality itself degrades if much delay arises, an object is how to assure QoS. Accordingly, so far, it has been in a general manner that the priority (precedence) of data to be transmitted is checked by priority identification information, called “class” so that the data are preferentially multiplexed and transferred in order of lowering priority (class). That is, in the existing communication unit (node) such as an IP router, for the communications requiring the real-time processing, high priority is assigned to the transmission data and packets are preferentially sent in order of lowering priority (see FIG. 12).

Meanwhile, limitation is imposed on packets which can be set at a high priority and the service charge is high. In addition, there is a case that high priority cannot be assigned to the packets. Still additionally, because of the preferential transmission of the packets having a high priority, difficulty is experienced in calculating (estimating) the degree of delay of packets with low priority.

Accordingly, when a real-time communication is made in some network, only the “best effort” type quality assurance is selectable which is for reducing the delay by setting the priority of packet transmission in each node, and in fact, the assurance on the actual transfer delay and the fluctuation does not exist (see FIG. 13). Moreover, for the degree of delay between terminals, the calculation becomes more difficult as the network becomes larger so that the scalability is unobtainable.

On the other hand, as mentioned above, for conducting the real-time communication, for example, a voice communication such as telephone, there is a need to buffer an incoming voice packet by a given constant quantity. Because fluctuation occurs at a packet arrival time, this buffering quantity is required to sufficiently cope with the fluctuation time for preventing the speech once regenerated from being interrupted.

In addition, since speech cannot be fast-forwarded after once regenerated, it is impossible to change the initial buffering quantity. However, when the length of buffering time becomes long, the echo (cross talk) that his/her own voice returns through the other receiver lowers the voice quality, and the resultant delay causes hard calling to do.

Accordingly, the key to optimize the buffering quantity is that it is set at as a small value as possible but in a range causing no interruption of calling. Moreover, also for the transmission of moving images, the important consideration is optimizing the buffering quantity.

Meanwhile, consideration is given to the transfer delay occurring in a general router. FIG. 14 shows a configuration of a general router and FIG. 15 illustrates a configuration of network interfaces thereof.

As FIG. 14 shows, the router is made up of a switch fabric 100 and network interfaces 200 connected to the switch fabric 100, with the number of the network interfaces 200 corresponding to the number of input/output ports. Each of the network interfaces 200 is composed of an input side interface 201 and an output side interface 202.

Moreover, as FIG. 15 shows, the input side interface 201 includes an input buffer 201a for storing a constant quantity of received packets and an destination settlement unit 201b for carrying out the destination settlement on the basis of a routing table of the received packets. The output side interface 202 includes an enqueue control unit 202a for identifying the classes of the received packets to distribute them to a plurality of queues (buffers) 202b according to class and a dequeue control unit 202c for reading out the packets from the queues 202b to output them.

In this router configuration, the principal factors to the above-mentioned transfer delay are the waiting of the received packets in the input buffer 201a for the destination settlement in the destination settlement unit 201b and the buffering (enqueue and dequeue processing) in the output side interface 202. However, in the existing apparatus, consideration is not given to the delay occurring at the destination settlement.

In addition, in the output side interface 202, the dequeue control unit 202c reads out packets from each of the queues 202b according to priority or band distribution set according to queue 202b or output line. Among the conventional band control methods using the dequeue control unit 202c, there are mainly the “fixed band control”, the “WFQ (Weighted Fair Queuing) control”, and other methods.

The above-mentioned “WFQ control” is typical priority control. This “WFQ control” is a technique for implementing the priority control on packets waiting for transmission, by utilizing various types of identifiers of IP packets. In principle, the queues 202b are weighted according to priority to enhance the transmission frequency of the packets stored in the queues with larger weight.

The further development of this WFQ technique produces the CBWFQ (Class Based Weighted Fair Queuing). This CBWFQ has features including 1) an extension version of the CQ (Custom Queuing), 2) the classification into 8/64/100, 3) the WFQ control among classes, 4) the RED (Random Early Detection) in class, 5) the Policing/Shaping for each class and 6) the SLA (Service Level Agreement) for each class.

In this CBWFQ, the classification is made according to outgoing/destination IP address of received packet, session (port, socket), protocol or the like to carry out the enqueue according to class for the band allocation based on the band distribution for each class.

In the nodes employing these band control methods, difficulty is experienced in seizing the actual length of delay time taken from the input of a packet to one node itself to the output thereof, which makes it difficult to seize the total delay time length among terminals and to determine the receive buffer quantity. Moreover, since difficulty is encountered in seizing the number of nodes having no band allocation assurance based on the SLA, existing on the path, in fact the quality assurance is not given to large-scale networks, particularly, outside networks (this signifies low scalability).

### SUMMARY OF THE INVENTION

The present invention has been developed with a view to eliminating the above-mentioned problems, and it is therefore an object of the invention to provide a packet communication apparatus with a transfer delay assurance function, capable of assuring a required communication quality by notifying information on the length of delay time in packet communication, assurable by packet communication apparatus positioned on a packet transfer path (route), to a called (destination) side packet communication apparatus for optimizing a receiving packet buffering quantity in the called side packet communication apparatus, and capable of realizing this assurance.

For this purpose, in accordance with the present invention, there is provided a communication quality assuring method for use in a packet communication system, comprising:

(1) for establishing a communication on a packet transfer path, notifying information on delay time of packet transfer, assurable with respect to a received packet quantity by one or more packet communication apparatus existing on the packet transfer path, to a destination (called) side packet communication apparatus; and

(2) making the destination side packet communication apparatus determine a received packet buffering quantity in a communication using the packet transfer path between the destination side packet communication apparatus and an origination (calling) side packet communication apparatus on the basis of the delay time information notified.

Thus, according to the present invention, for making a communication between some packet communication apparatus (for example, between terminals or between edge nodes of a packet communication network), a destination side packet communication apparatus can previously learn the length of delay time in the transfer of packets, coming from an origination side packet communication apparatus, at a packet communication apparatus on a packet transfer path. This adaptively secures and optimizes the received packet buffering quantity which satisfies a communication quality necessary for the communication using the packet transfer path.

In addition, in accordance with the present invention, there is provided a packet communication apparatus with a transfer delay assurance function, comprising the following parts:

(1) a transmission buffer unit for buffering a received packet;

(2) a monitor unit for monitoring the length of left time from an arrival time of the received packet before (with respect to) a delay assurance time by which transmission processing of the received packet is to be completed; and

(3) a buffering control unit for controlling buffering of the received packet into the transmission buffer unit on the basis of a result of the monitoring by the monitor unit so that a received packet having a shorter length of left time is transmitted more preferentially.

In the packet communication apparatus thus made according to the present invention, since the received packet buffering control (transmission control) is implemented in a manner that the priority (precedence) is set on the basis of the length of left time from the arrival time of a received packet before a delay assurance time by which the transmission (transfer) processing of the received packet is to be completed, the received packet transmission can be conducted in a state where much consideration is given to the aforesaid delay assurance time.

As a result, in a packet communication system using this packet communication apparatus, it is possible to decrease the uncertain elements about a packet delay quantity, such as the length of packet transfer delay time, fluctuation or the like, on a packet transfer path to be used for communications between some packet communication apparatus and to specify the communication quality assurable in the communications using this packet transfer path.

In this case, preferably, the above-mentioned monitor unit includes a delay assurance time calculating means for calculating the aforesaid delay assurance time on the basis of information on a transmission packet quantity from an origination side packet communication apparatus, notified in advance from a destination side packet communication apparatus. Thus, with respect to the actual packet quantity to be transmitted from the origination side packet communication apparatus, it is possible to calculate the length of delay assurance time assurable by itself.

In addition, it is also appropriate that the above-mentioned transmission buffer unit includes an urgent output buffer for storing a received packet required to be urgently outputted because the left time length therefor, monitored by the aforesaid monitor unit, is shorter than a predetermined period of time, and the aforesaid buffering control unit includes an urgent output control means for, when a received packet exists in the urgent output buffer, reading out the received packet from the urgent output buffer as a first priority. This can transfer the received packets having a very short length of left time as a first priority, which enables keeping strictly to the aforesaid delay assurance time.

Furthermore, preferably, this packet communication apparatus includes a delay assurance time notifying means for notifying the aforesaid delay assurance time to the destination side packet communication apparatus. Thus, the destination side packet communication apparatus can learn the length of delay time in the packet transfer on the packet transfer path in advance as mentioned above, which enables adaptively securing and optimizing the received packet buffering quantity satisfying the communication quality enough for communications using the aforesaid packet transfer path.

Accordingly, the present invention can offer the following effects and advantages.

(1) When an origination side terminal notifies the delay assurance time length, obtained by making an inquiry at a packet communication apparatus, to a destination side, the destination side can learn a possible delay time length on a packet transfer path and, hence, can adaptively determine and optimize a its own received packet buffering quantity, which can cope with the degradation of communication quantity stemming from delay quantity or fluctuation in communication to secure a required communication quality even in a large-scale network.

(2) Since a packet communication apparatus can more preferentially transfer real-time packets having shorter left time length from the packet arrival time before the maximum delay assurance time, it is possible to assure the maximum value of packet transfer delay occurring in a packet communication apparatus. In consequence, a required communication quality (QoS) between packet communication apparatus is easily securable even in a large-scale network, thus enhancing the communication quality in real-time communications at a low cost.

(3) Since the aforesaid delay assurance time length can be calculated on the basis of information on a transmission packet quantity of an origination side packet communication apparatus notified in advance from a destination side packet communication apparatus, it is possible to obtain a length of delay assurance time suitable for a packet quantity the packet communication apparatus receives actually, thus realizing a surer delay assurance as compared with a case in which the delay assurance time length is simply fixed.

(4) Since, between a class of traffic (packet) on which the preferential readout control is implemented in consideration of the length of time left before a delay assurance time and a class independent of the left time length (the preferential readout control is not implemented), the readout priority can be changed on the basis of a packet size and a length of left time, the equalization of the delay time length becomes feasible.

(5) Received packets having a short length of time left before the delay assurance time are held in an urgent output buffer, and if received packets exist in the urgent output buffer, these received packets can be read out as a first priority, thus completing the transmission (transfer) of the packets for certain within the delay assurance time period.

### BRIEF DESCRIPTION OF THE DRAWINGS

FIG. 1 is a block diagram showing a configuration of a packet communication system according to an embodiment of the present invention;

FIG. 2 is a block diagram showing a configuration of a router shown in FIG. 1;

FIG. 3 is a block diagram showing a configuration of a network interface of the router shown in FIG. 2;

FIG. 4 is a sequence illustration useful for explaining an operation (negotiation) of the packet communication system shown in FIG. 1;

FIG. 5 is an illustration useful for explaining an operation at the negotiation in the router shown in FIG. 2;

FIG. 6 is an illustration useful for explaining the concept of a maximum length of delay assurance time in the router according to this embodiment;

FIG. 7 is an illustration useful for explaining a write operation in the router shown in FIGS. 2 and 3;

FIG. 8 is a block diagram showing a configuration of a buffer management unit shown in FIG. 3;

FIG. 9 is an illustration of one example of a management table for each queue, which is held in a main CAM shown in FIG. 8;

FIG. 10A is an illustration of one example of a readout queue head management table held in a readout queue head management register shown in FIG. 8;

FIG. 10B is an illustration of one example of a write queue last management table held in a write queue last management register shown in FIG. 8;

FIGS. 11A and 11B are illustrations useful for explaining an readout operation of a readout control unit shown in FIG. 3;

FIG. 12 is a block diagram showing a conventional packet communication system;

FIG. 13 is an illustration for explaining the problems of a conventional packet communication system;

FIG. 14 is a block diagram showing a configuration of a router constituting the packet communication system shown in FIGS. 12 and 13; and

FIG. 15 is a block diagram showing a configuration of a network interface shown in FIG. 14.

### DESCRIPTION OF THE PREFERRED EMBODIMENTS

An embodiment of the present invention will be described hereinbelow with reference to the drawings.

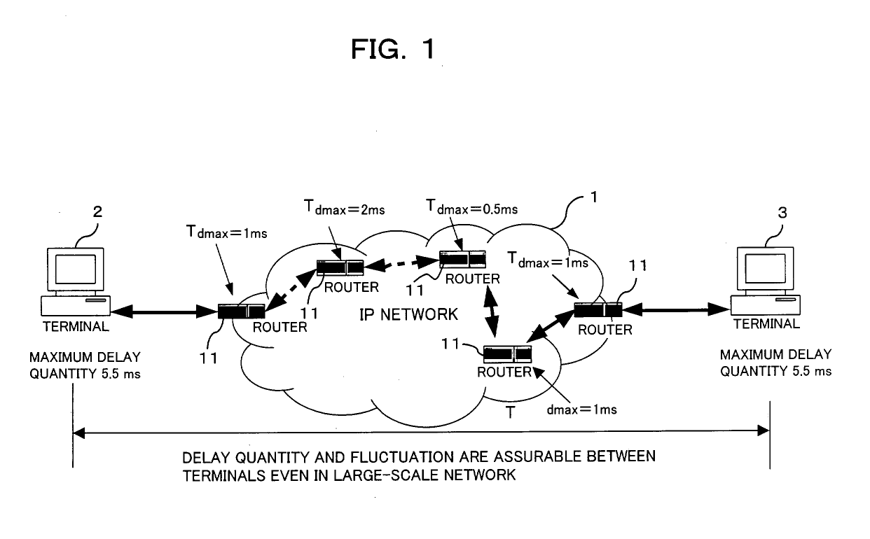

FIG. 1 is a block diagram showing a configuration of a packet communication system according to an embodiment of the present invention. In FIG. 1, the packet communication system is made up of an IP network (packet communication network) 1 composed of a plurality of routers (packet communication apparatus) 11, and terminals (packet communication apparatus) 2 and 3 such as personal computers capable of mutually making communications with each other through the IP network 1. Incidentally, naturally, the number of routers (each of which will equally be referred to as a “node”) 11 and the number of terminals 2 and 3 are not limited to those illustrated in FIG. 1.

In this embodiment, the quantity of packet transfer delay occurring in one node 11 is defined as a maximum delay quantity (length of time) Tdmax, and if the one node 11 can assure the transfer of the packets within the maximum delay time length Tdmax, the calculation of the length of delay time required for transmission throughout the entire IP network 1 becomes easily feasible by making an inquiry at one, or two or more, nodes 11 lying on a packet transfer path used for communications between the terminals 2 and 3.

For the realization, in this embodiment, each of the routers 11 constituting the IP network 1, as will be mentioned later, has a timer function and is designed as a packet communication apparatus with a transfer delay assurance function capable of completing the transfer of a received packet within a limited period of time (maximum delay assurance time length) from when the received packet arrives until the transmission (transfer) processing is required to be completed.

In addition, for example, for establishing the communication between the terminals 2 and 3, the origination side terminal 2 or 3 previously notifies information on a packet quantity to be transmitted to the destination side (called side) terminal 3 or 2 to one, or two or more, routers existing on a packet transfer path extending to the destination side terminal 3 or 2 through the use of a packet, called a “query packet”, thereby making an inquiry about (obtaining) a maximum length of delay assurance time this router 11 can provide with respect to that packet quantity.

Still additionally, when the origination side terminal 2 or 3 notifies the obtained maximum delay assurance time length (total) to the destination side terminal 3 or 2, the terminal 3 or 2 acting as a destination terminal can previously learn the maximum delay assurance time length for the packet from the origination side terminal 2 or 3 in the router 11 lying on the packet transfer path. As a result, it is possible to adaptively determine and optimize its own received packet buffering quantity on the basis of the notified maximum delay assurance time length, thereby, even in the large-scale IP network 1, coping with the degradation of the communication quality stemming from the delay quantity or fluctuation in the communication between the terminals 2 and 3 for securing the needed communication quality (QoS).

That is, in the example shown in FIG. 1, since the maximum delay assurance time lengths Tdmax of the five routers 11 are 1 ms, 2 ms, 0.5 ms, 1 ms and 1 ms, the terminal 3 or 2 acting as a packet reception terminal determines, as a minimum receive buffering quantity required, a buffering quantity for which a delay time of 5.5 ms, i.e., the sum of these maximum delay assurance time lengths Tdmax, is assurable.

A detailed description will be given hereinbelow of a configuration of the router 11 which realizes this function (transfer delay assurance function).

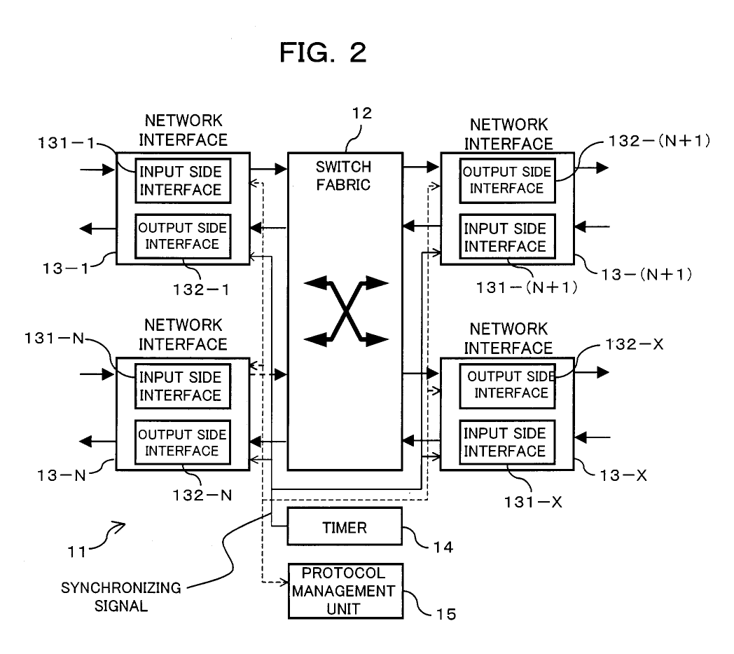

FIG. 2 is a block diagram showing a configuration of the router 11 according to an embodiment of the present invention. In FIG. 2, the router 11 is made up of a switch unit (switch fabric) 12, network interfaces 13-1 to 13-N, 13-(N+1) to 13-X (N and X signify natural numbers, satisfying N<X) corresponding in number to input/output ports, a timer 14 and a protocol management unit 15. Each of the network interfaces 13-i (i=1 to X) is composed of an input side interface 131-i and an output side interface 132-i.

The timer 14 is for sending a timer signal (synchronizing signal) to each of the interfaces 13-i (131-i, 132-i) without delay to measure time information standardized in the node 11 itself (make time synchronization), and the protocol management unit 15 has a function to carry out the negotiation about a maximum length of delay assurance time corresponding to a received packet quantity in the node 11 itself, which will be mentioned later.

The switch fabric 12 is for conducting a switching operation to route an inputted packet, inputted from the network interface 13-i (input side interface 131-i), to the network interface 13-i (output side interface 132-i) for a desired output port according to the contents of a destination header of the inputted packet.

In this connection, this switch fabric 12 is sometimes constructed as an ATM switch which converts a received packet into an ATM (Asynchronous Transfer Mode) cell at the input side interface 131-i for switching the received packet on the ATM cell basis.

In addition, the input side interface 131-i of the network interface 13-i is for mainly conducting the reception processing (buffering, destination settlement based on a predetermined routing table, and others) on received packets from the line side, while the output side interface 132-i of the network interface 13-i is for conducting the transmission processing (buffering, and others) on packets inputted from the switch fabric 12.

However, in this embodiment, in addition to the above-mentioned basic function, the input side interface 131-i is made to add information on an arrival time and a period of time (delay time length) taken for the destination settlement, to a received packet, and in the output side interface 132-i, on the basis of the information added to the received packet in this way, the buffering (packet write and readout processing) is controlled so that packets are surely sent out within a maximum delay compensation time obtained through the prior negotiation processing with the terminal 2 or 3.

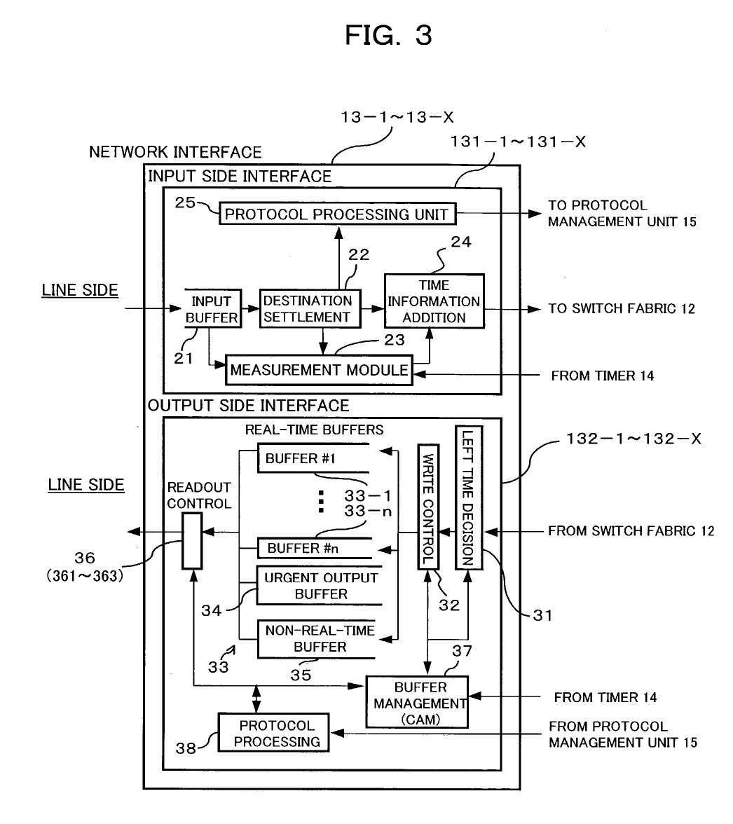

Thus, for example, as shown in FIG. 3, the input side interface 131-i includes an input buffer 21, a destination settlement unit 22, a measurement module 23, a time information adding unit 24 and a protocol processing unit 25, while the output side interface 132-i includes a left time decision unit 31, a write control unit 32, a readout control unit 36, a buffer management unit 37, a protocol processing unit 38, and a transmission buffer unit 33 comprising a plurality of real-time buffers 33-1 to 33-n (queues #1 to #n), an urgent output buffer (queue) 34 and a non-real-time buffer (queue) 35.

In this configuration, in the input side interface 131-i, the input buffer 21 is for temporarily holding received packets from the line side. The destination settlement unit 22 is for conducting predetermined destination settlement processing on the basis of destination header information of a received packet outputted from the input buffer 21. At this time, if the received packet is a control packet such as a query packet addressed to itself, it is transferred to the protocol processing unit 25.

The measurement module 23 is made to be capable of monitoring, on the basis of the time length measured by the timer 14, an arrival time (time of writing in the input buffer 21) of a received packet, a delay time length (destination settlement time length) needed for the destination settlement in the aforesaid destination settlement unit 22, a delay time length (switching time length) stemming from the switching in the switch fabric 12, and others. However, it can be considered that each of the destination settlement time length and the switching time length is an eigenvalue, i.e., a value peculiar to the router 11.

The time information adding unit 24 is for adding, to a received packet, the aforesaid information (at least arrival time information) obtained by the measurement module 23, and the protocol processing unit 25 is for notifying, to the protocol management unit 15, the contents of a self-addressed control packet such as query packet, with the protocol processing being conducted according to a received control packet in the protocol management unit 15.

Concretely, in this embodiment, the protocol processing unit 25, the protocol management unit 15 and the protocol processing unit 38 operate in cooperation with each other, thereby, upon receipt of a request (query packet) for a real-time data traffic requiring a new quality (delay time length) assurance, realizing a function to make the negotiation with respect to the terminal 2 or 3 acting as a destination terminal for seizing an assurable delay quantity. That is, the protocol management unit 15 functions as a delay assurance time notifying unit to notify a length of delay assurance time in the node 11 itself to the destination side terminal 2 or 3.

On the other hand, in the output side interface 132-i, the left time decision unit 31 is for, on the basis of the arrival time information added to a packet inputted from the switch fabric 12, making a decision on a left time length before a maximum delay assurance time by which the packet is required to be transmitted, and the write control unit 32 is for writing (enqueuing) an inputted packet in one of the transmission buffer unit 33 (the real-time buffers 33-1 to 33-n), the urgent output buffer 34 and the non-real-time buffer 35 according to the decision result in the left time decision unit 31 and the service type for the inputted packet, or the like.

In this connection, in the real-time buffers 33-1 to 33-n is held a data traffic (packet) on an application such as voice communication or moving image transmission requiring real-time processing. The packet (which sometimes will be referred to as a “real-time packet”) held therein is read out (dequeued) by the readout control unit 36 to be completely sent out (transferred) within a maximum delay time length.

On the other hand, in the urgent output buffer 34 is held, of the real-time packets, an urgent output required packet having an extremely short length of left time until a maximum delay assurance time. If a packet exists therein, that packet is read out by the readout control unit 36 as a first priority.

Moreover, in the non-real-time buffer (non-priority control buffer) 35 is held a data traffic (packet), such as FTP (File Transfer Protocol), HTTP (Hyper Text Transfer Protocol) or SMTP (Simple Mail Transfer Protocol), in which the delay and fluctuation of transmission data are less of a problem (there is almost no need to consider the delay time length). In a case in which packets exist in the real-time buffers 33-1 to 33-n, the packets (which sometimes will be referred to as a “non-real-time packet”) held in the non-real-time buffer 35 are successively read out by the readout control unit 36 provided that the real-time packet can be transferred within a maximum delay time length.

The readout control unit 36 is made to implement the above-mentioned preferential readout control in accordance with schedule data (for example, information on storage positions of packets to be dequeued next, in the buffers 33-1 to 33-n, 34 and 35) managed by the buffer management unit 37, and for example, serves as the following functional parts:

(1) an urgent output control section 361 for, when a received packet exists in the urgent output buffer 34, reading out the received packet from the urgent output buffer 34 as a first priority;

(2) a buffer readout decision section 362 for, on the basis of packet size information on a received packet stored in the non-real-time buffer 35 and a left time length for a received packet stored in the real-time buffers 33-1 to 33-n, making a decision as to whether or not the received packet stored in the real-time buffers 33-1 to 33-n can be readout before the expiration of the aforesaid left time length even if the received packet stored in the non-real-time buffer 35 is read out; and

(3) a determination section 363 for, if the decision of the buffer readout decision section 362 shows that the received packet stored in the real-time buffer 33-1 to 33-n can be read out before the expiration of the left time length, determining the received packet stored in the non-real-time buffer 35 as a readout object.

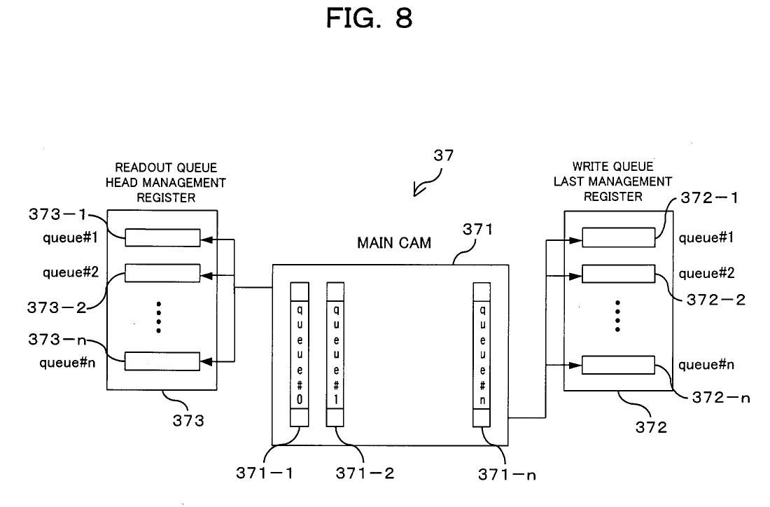

Furthermore, the buffer management unit 37 functions as a buffer management circuit for managing buffers 33-j (j=1 to n), 34 and 35 through the use of a CAM (Content Addressable Memory) and as a buffer management table, and is for selecting a packet to be read out from the buffers 33-j, 34 and 35, in which packets exist, to give a dequeue instruction on that packet to the readout control unit 36, the retrieval of the buffers 33-j, 34 and 35 having a packet(s) to be read out next and the updating of the contents of the buffer management table being made at every packet readout. Incidentally, a detailed operation of this buffer management unit 37 will be described later with reference to FIGS. 8 to 10.

The protocol processing unit 38 cooperates with the protocol management unit 15 for conducting the above-mentioned negotiation and, on the basis of information on a communication condition thus derived, obtains a length of delay assurance time assurable by the node 11 itself with respect to that communication condition.

That is, in this embodiment, the left time decision unit 31, the buffer management unit 37 and the protocol processing unit 38 function as a monitor means to, on the basis of time information given by the timer 14, monitor a length of left time from the arrival of a received packet with respect to the delay assurance time by which the transmission processing on that received packet is required to be completed, while the write control unit 32 and the readout control unit 36 function as a buffering control means to, on the basis of the result of the monitoring by this monitor means, control the received packet buffering into the buffers 33-1 to 33-n, 34 and 35 so that a received packet having a shorter length of left time is transmitted more preferentially.

With the above-described configuration, the node 11 according to this embodiment can secure the time length, from which a packet is inputted to an input side interface 131-i of one network interface 13-i until the same packet is outputted through the switch fabric 12 to an output side interface 132-k (line side) of another (or the same) network interface 13-k (k=1 to X), before a maximum delay assurance time.

A detailed description will be given hereinbelow of an operation of the packet communication system (node 11) thus configured according to this embodiment.

(1) Negotiation Processing About Maximum Delay Assurance Time Length

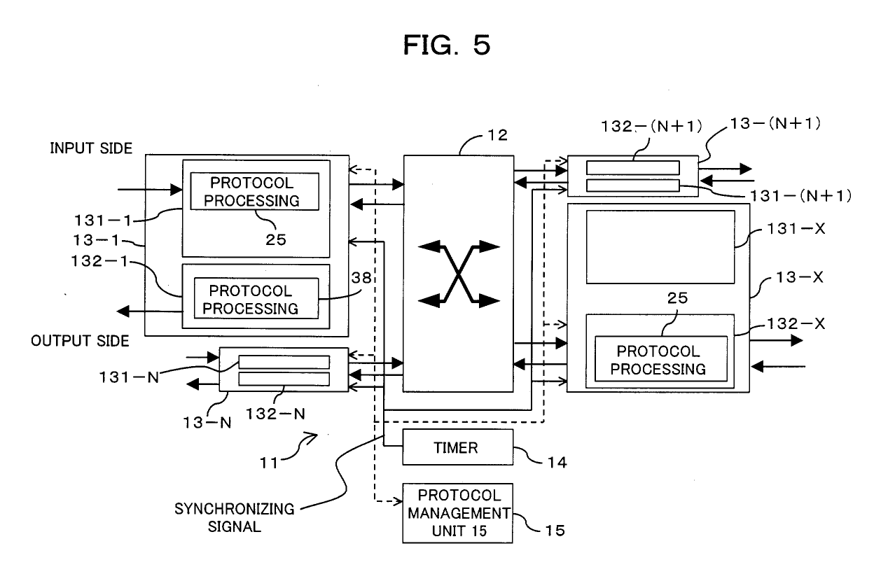

First, referring to FIG. 5, a description will be given hereinbelow of negotiation processing in a case in which, in FIG. 1, a packet is transmitted from the terminal 3 to the terminal 2 (that is, in a state where the terminal 3 acts as an origination side terminal while the terminal 2 serves as a destination side terminal) For conducting the following negotiation processing, the protocol management unit 5 and the protocol processing units 25 and 38 cooperate with each other.

For example, when accepting a moving image delivery service from the origination side (calling side) terminal 3 (which sometimes will be referred to as a “origination terminal 3”), the destination side (called side) terminal (which sometimes will be referred to as a “destination terminal 2”) sends, to the origination terminal 3, a service request packet addressed to the origination terminal 3. In this service request packet stores, the header stores an IP address of the destination terminal 2 as a calling-side address, and when receiving this service request packet, the origination terminal transmits moving image data in a state where the calling-side address is used as a destination address.

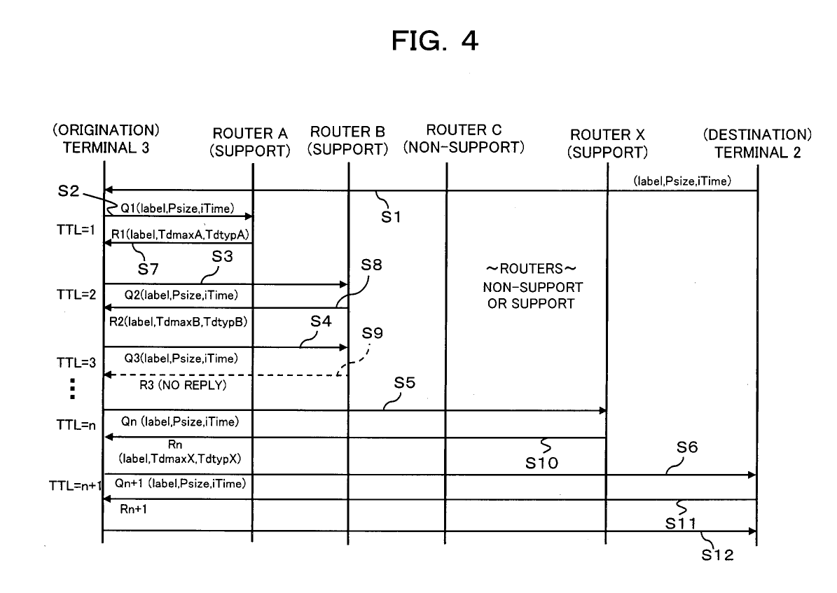

Meanwhile, prior to the transmission of this moving image data, the origination terminal 3 transmits a trigger packet indicative of the start of the communication to the destination terminal 2, and when receiving this trigger packet, as shown in FIG. 4, the destination terminal 2 notifies, to the origination terminal 3, a label for the identification of that communication flow and a communication condition [transmission packet size Psize (byte) and packet frequency (packet transmission interval) iTime (second)] and others through the use of a packet (step S1).

In this case, for example, the “label” can be an element in the “class” definition for use in a set of the terminals 2 and 3 on IP address and a general CBWFQ such as protocol, or can be a label for use in MPLS (Multi-Protocol Label Switching). However, in this case, it is used on the assumption that the MPLS label distribution based on LDP (Label Distribution Protocol) or the like has already been carried out.

Following this, the origination terminal 3 transmits a plurality of query packets Qx (x=1, 2, 3, . . . ), addressed to the destination terminal 2 and different in TTL (Time To Live) decremented by one whenever passing through a router 11 (steps S2 to S6). These query packets Qx include information on a label, a packet size (Psize), a packet transmission internal (iTime) and others sent from the destination terminal 2.

Thus, the query packets Qx are successively transferred to the routers 11 (in FIG. 4, expressed by routers A, B, C, . . . . , X) until TTL=0, thereby arriving at each of one, or two or more, routers 11 taking different packet transfer paths to the destination terminal 2 (each of the routers 11 consider that the query packet having TTL=0 is addressed to itself).

In addition, in a case in which each of the routers 11 supports this protocol, the router 11 returns, to the origination terminal 3, a maximum delay time length (TdmaxA, TdmaxB, . . . ) it can assure at that time and an average transmission time length (desired output time length: TdtypA, TdtypB, . . . ) through the use of a reply packet Rx (steps S7, S8, S10). Incidentally, in the case of a router 11 which does not support this protocol, this return does not take place (step S9). Still additionally, with respect to a query packet Qn+1 arriving at the destination terminal 2, a packet indicative of the query packet reception is returned as a reply packet Rn+1 from the destination terminal 2 to the origination terminal 3 (step S11).

Moreover, the origination terminal 3 receives the reply packet Rn+1 from the destination terminal 2 for recognizing the completion of the negotiation processing, and calculates the sum of the returned maximum delay assurance time lengths of the respective routers 11 to notify the obtained total delay assurance time length to the destination terminal 2 (step S12). This enables the destination terminal 2 to optimize its own reception buffering size and readout threshold. In this connection, also in the case of the opposite direction (terminal 2→terminal 3), a sequence similar to that mentioned above can be implemented, thereby achieving the bidirectional quality assurance.

Still moreover, although it can be considered that a protocol non-supporting router(s) 11 exists on the packet transfer path as mentioned above, since the destination terminal 2 can shorten an unknown delay time length forming an uncertain element in calculating its own buffering size and readout threshold, the regeneration quality at communication is improvable.

Secondly, taking note of processing in a router 11 (for example, a router B shown in FIG. 4), a description will be given hereinbelow of the above-described negotiation processing.

First, let it be assumed that the router 11 receives a query packet Q2 at the input side interface 131 if the network interface 13-1. This query packet Q2 is handed over to the protocol processing unit 25 which in turn, retrieves/specifies the output side interface 132-i (for example, an output side interface 132-X) corresponding to the destination terminal 3 forming the call destination on the basis of a destination address set in the query packet Q2 and notifies that information to the protocol management unit 15.

The protocol management unit 15 has a management table including the contents (entry) such as a label of a flow for assuring a packet transfer delay time length among all the network interfaces 13-i in the router 11 it pertains to, a packet size, a packet frequency, a buffering time length (Tbuff), a maximum delay assurance time length (Tdmax) and a setting time. The protocol management unit 15 calculates the present maximum delay assurance time length assurable by the output side interface 132-X, on the basis of the entry of the management table, and registers the entry of the maximum delay assurance time length with respect to the query packet Q2.

In addition, the protocol management unit 15 notifies the contents to be returned as a reply packet R2 to the origination terminal 3, to the protocol processing unit 38 of the output side interface 132-1 of the network interface 13-1 receiving the query packet Q2, and further notifies a label and a maximum delay assurance time length to the protocol processing unit 25 of the output side interface 132-X of the network interface 13-X.

Thus, the protocol processing unit 25 of the output side interface 132-X sets (registers) the label of the flow for the delay time assurance and the maximum delay assurance time length for the buffer management unit 37 and, thereafter, the packet transfer processing assuring the set maximum delay assurance time length is conducted with respect to the actual flow.

In this connection, when the processing of the transmission from origination terminal 3 comes to an end and the protocol processing unit 25 of the input side interface 131-1 receives a communication completion notification, this notification is forwarded through the protocol management unit 15 to the protocol processing unit 25 of the output side interface 132-X, and after the entry of the conformable flow in the buffer management unit 37 is deleted and the delay assurance processing is canceled, the conformable entry is removed from the management table of the protocol management unit 15.

(2) Calculation of Delay Assurance Time Length

Furthermore, a description will be given hereinbelow of a method of calculating a delay assurance time length in the aforesaid protocol management unit 15.

Since limitation is imposed on the resource in the IP network, there is a need to limit the flow for the priority (delay time assurance) control for the quality assurance. The delay assurance time length (assurable time length) varies with the quantity of the delay assurance traffic existing at that time. Originally, this is for preventing the failure of the delay assurance function due to the setting of an impossible assurable delay time length.

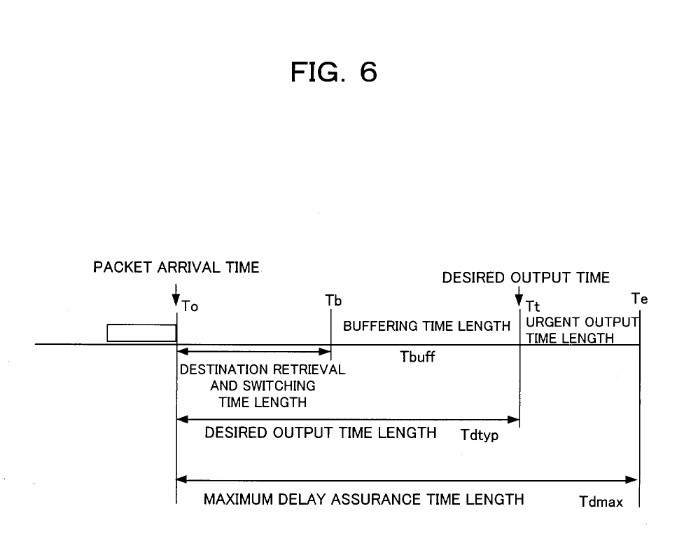

FIG. 6 is an illustration of the outline of a delay assurance time length and one example of a calculation method therefor.

Let it be assumed that, as shown in FIG. 6, an expected time length (desired output time length) from which a packet arrives at a node 11 (arrival time T₀) until the packet is outputted is taken as Tdtyp and, in a case in which there is a flow for the quality assurance of m flows at present, the delay assurance time length of the m+1th flow is obtained. When a new packet frequency is taken as Tfreq(1/s) and a time length per output of one bit in the apparatus is taken as Tout(s), the desired output time length Tdtyp is expressed as follows.

Tdtyp=destination settlement time length+switching time+ΣTbuff(i)×Tout (1)

However, in this equation (1), i=1 to m+1 and Σ signifies the total sum of buffering time lengths Tbuff of flows of 1 to m+1. At this time, if the destination settlement time length and the switching time length are considered as eignvalues peculiar to the router 11, the desired output time length Tdtyp depends only on ΣTbuff(i)×Tout.

Moreover, Tbuff(i)=[packet size(i)×packet frequency(/s)(i)]/Tfreq (2)

That is, the buffering time length Tbuff denotes a time length necessary for the output of a data quantity of the existing flow, with it being outputted per output interval time (the inverse of the packet frequency) of a new flow. Moreover, the maximum delay assurance time length Tdmax can be expressed as follows in the case of, for example, twice the packet of a quality assurance flow.

Tdmax=Tdtyp+2×ΣTbuff(i)×Tout (3)

As described above, this protocol processing unit 38 also functions as a delay assurance time calculation section 381 (see FIG. 3) to calculate a delay assurance time length on the basis of information on a transmission packet quantity of the origination side terminal 3 or 2 previously notified from the destination side terminal 2 or 3 through the above-mentioned negotiation.

The desired output time length Tdtyp and the maximum delay assurance time length Tdmax, obtained in this way, are notified to the protocol processing unit 38 of the output side interface 131-i, and in the buffer management unit 37, a desired output time Tt and a maximum delay assurance time Te with respect to the packet arrival time (T₀) are obtained, and they are put (registered) in the management table for each queue in the buffer management unit 37 as will be mentioned later.

Thus, in the node 11, it is possible to obtain a delay assurance time length suitable for a packet quantity it receives actually, and to realize surer delay assurance as compared with a case of the simple fixing of the delay assurance time length.

(3) Selection of Queue

Still furthermore, a description will be given hereinbelow of queue selection processing for buffering of received packets.

This queue selection is carried out in a manner that the left time decision unit 31 operates in cooperation with the buffer management unit 37. That is, the left time decision unit 31 first makes a decision as to whether or not a new received packet is a real-time packet or a non-real-time packet (packet such as FTP, HTTP, SMTP or the like). If the decision shows a non-real-time packet, the value of Tbuff is set at infinity, and the non-real-time buffer 35 is selected as a storing place for the new received packet.

On the other hand, if the decision shows a real-time packet, the left time decision unit 31 calculates a desired output time Tt(new) on the basis of the new received packet arrival time T0+the desired output time Tdtyp, and compares this desired output time Tt(new) with a desired output time Tt(end) of the last packet of each of the queues 33-i. The queue 33-i satisfying “Tt(new)>Tt(end)(i) and the desired output time Tt(end)(i) of the last packet indicates a maximum” (condition 1) is selected as a storing place.

Meanwhile, in a case in which the aforesaid comparison is repeatedly made on the respective queues 33-i but all the queues 33-i do not satisfy the aforesaid condition 1, the left time decision unit 31 calculates a maximum delay assurance time Te(new) on the basis of the new received packet arrival time T0+the maximum delay assurance time length Tdmax, and compares this maximum delay assurance time Te(new) with a desired output time Tt(end) of the last packet of each of the queues 33-i. The queue 33-i satisfying “Te(new>Tt(end)(i) and the desired output time Tt(end)(i) of the last packet shows a minimum” (condition 2) is selected as a storing place.

Moreover, in the case of no satisfaction of both the conditions 1 and 2, the left time decision unit 31 selects the urgent output buffer 34 as a storing place for the new received packet.

The above-mentioned selection result is notified to the write control unit 32 so that the new received packet is written in the conformable buffer 33-i, 34 or 35 by the write control unit 32.

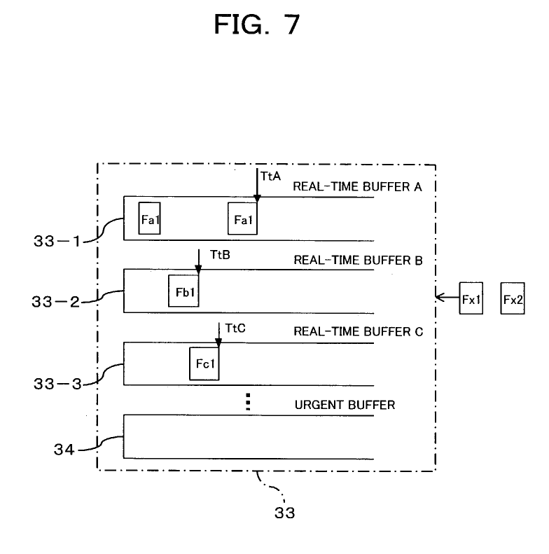

As one example, considering a state shown in FIG. 7. In the case shown in FIG. 7, first, a desired output time “Tt(1)” of a new received packet “Fx1” is compared with each of desired output times “TtA”, “TtB” and “TtC” of the last packets of the queues 33-i. The write control unit 32 writes the new received packet “Fx1” in the queue 33-i satisfying the condition 1 (the desired output time “Tt” of the last packet is lower than the desired output time “Tt(1)” of the new received packet “Fx1” and it shows a maximum).

On the other hand, in the case of no satisfaction of the condition 1, the maximum delay assurance time “Te(1)” of the new packet “Fx1” is compared with “TtA”, “TtB” and “TtC” of the last packets of the queues 33-i. The write control unit 32 writes the new received packet “Fx1” in the queue 33-i satisfying the condition 2 (the desired output time “Tt” of the last packet is lower (earlier) than the maximum delay assurance time “Te(1)” of the new received packet “Fx1” and it shows a minimum).

Meanwhile, in the case of no satisfaction of both the aforesaid conditions 1 and 2, the new received packet “Fx1” is written in the urgent output buffer 35 by the write control unit 32. Thus, even in a case in which difficulty is encountered in keeping to the maximum delay assurance time Te, for example, if much time is required for the destination settlement, the packet held in the urgent output buffer 35 can be outputted as a first priority.

(4) Queue Management Method

Referring to FIGS. 8 to 10, a description will be given hereinbelow of one example of a queue management method based the above-mentioned queue selection conditions in the buffer management unit 37.

As FIG. 8 shows, for example, the buffer management unit 37 is made up of a main CAM 371 for holding management tables 371-1 to 371-n for queues #1 to #n, a write queue last management register 372 for holding write queue last packet management tables 372-1 to 372-n for the queues #1 to #n, and a readout queue head management register 373 for holding readout queue head management tables 373-1 to 373-n for the queues #1 to #n.

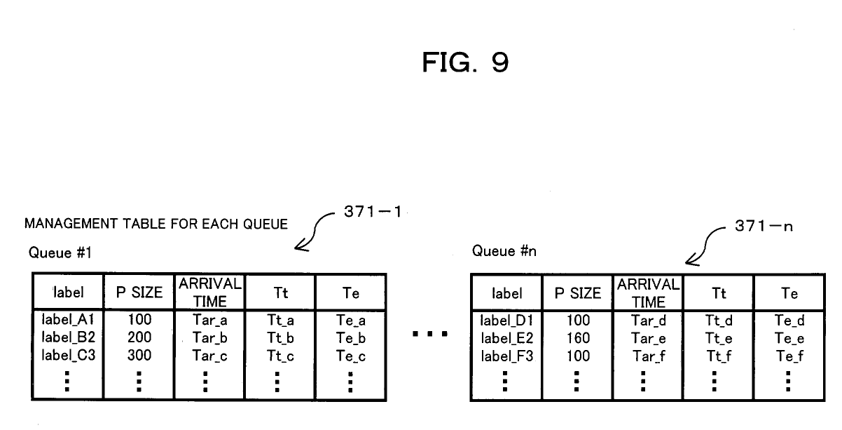

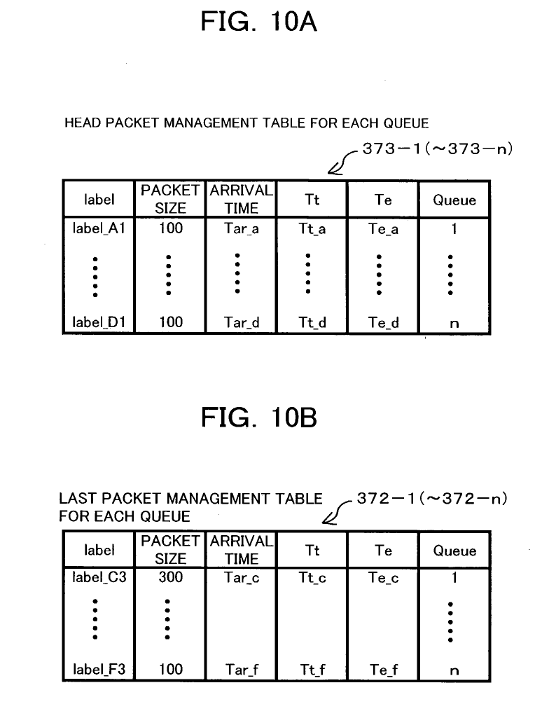

In addition, for example, as shown in FIG. 9, in each of the management tables 371-1 to 371-n are put (registered) information, such as a packet size, an arrival time, a desired output time Tt and a maximum delay assurance time Te, on a packet held. Moreover, for example, as shown in FIG. 10B, in each of the write queue last packet management tables 372-1 to 372-n are put information, such as a label, a packet size, an arrival time, a desired output time Tt, a maximum delay assurance time Te and queue number, on a packet written at the last of the queue #j, and further, as shown in FIG. 10A, in each of the readout queue head packet management tables 373-1 to 373-n are put information, such as a label, a packet size, an arrival time, a desired output time Tt, a maximum delay assurance time Te and queue number, on the leading packet of the queue #j.

Thus, the times by which the transmission (readout) of packets of each queue “j are to be completed are collectively managed by the buffer management unit 37 through the use of the management tables 371-j, 372-j and 373-j.

A description will be given hereinbelow of an operation of this buffer management unit 37. In this case, let it be assumed that the output side interface 132-i (protocol processing unit 38) has the information (label, packet size, interval, and others) obtained through the above-mentioned negotiation in the protocol management unit 15.

First, when a new packet arrives at the output side interface 132-i, the left time decision unit 31 extracts the arrival time T0 added to the new packet in the input side interface 131-i, and the protocol processing unit 38 and the protocol management unit 15 calculates a desired output time Tt and a maximum delay assurance time Te on the basis of the present time given by the timer 14 [see the aforesaid equations (2) and (3)].

In addition, when the aforesaid new packet is written by the write control unit 32 according to the above-mentioned buffer selection processing, the value thereof is registered in the management table 371-j of the conformable queue #j, and the contents of the write queue last packet management table 372-j of the conformable queue #j are updated in connection with this registration.

Still additionally, whenever a packet is read out from each queue #j, the buffer management unit 37 reads out the entries of the head and last packets of the queue #j from the management table 371-j. Moreover, it puts them in the corresponding registers 372 and 373 (management tables 372-j and 373-j) and reduces the desired output times Tt and maximum delay assurance times Te of the head and last packets of the queue #j for each queue #j in units of unit time according to a synchronizing signal from the timer 14. This means that a packet having a lower desired output time Tt has a shorter left time length before the desired output time Tt while a packet having a lower maximum delay assurance time Te has a shorter left time length before the maximum delay assurance time Te.

In this connection, in a state where only one packet is held in the queue #j, the head packet=the last packet, and this means that the information on this packet is registered in the readout head packet management table 373-j.

In the readout processing, the readout control unit 36 first checks whether or not a packet (that is, packet having an extremely short left time length before the maximum delay assurance time Te (packet in the “urgent output time length” shown in FIG. 6) exists in the urgent output buffer 34. If a packet(s) exists in the urgent output buffer 34, as a first priority, the readout control unit 36 reads out the packet held in the urgent output buffer 34 through the use of the function as the urgent output control means 361 (see FIG. 3).

On the other hand, if the packet is absent in the urgent output buffer 34, the readout control unit 36 sees the readout head packet management table 373-j to first check the maximum delay assurance time Te of the head packet of each of the queues (real-time buffers) #j for more preferentially reading out successively the packets having a lower maximum delay assurance time Te, and then checks the desired output time Tt to more preferentially read out successively the packets having a lower desired output time Tt. In this way, the real-time packets are preferentially read out so as not to exceed the maximum delay assurance time Te.

In this connection, if packets with a packet size exists in the non-real-time buffer 35, the readout control unit 36 makes a decision, through the use of the function of the buffer readout decision section 362, whether, even if the head packet thereof is sent out therefrom, the sending of the packet having the lowest maximum delay assurance time Te and lowest desired output time Tt in the real-time buffer #j is completable or not. If the sending thereof is completable, the readout control unit 36 determines the non-real-time packets as packets to be read out through the use of the function of the determining section 363 and reads them out.

Through this readout control, between a class of traffic (packet) on which the preferential readout control is implemented on the basis of the length of left time and a class independent of the left time length (the preferential readout control is not implemented), the readout priority can be changed on the basis of a packet size and a length of left time, thereby enabling the equalization of the delay time length.

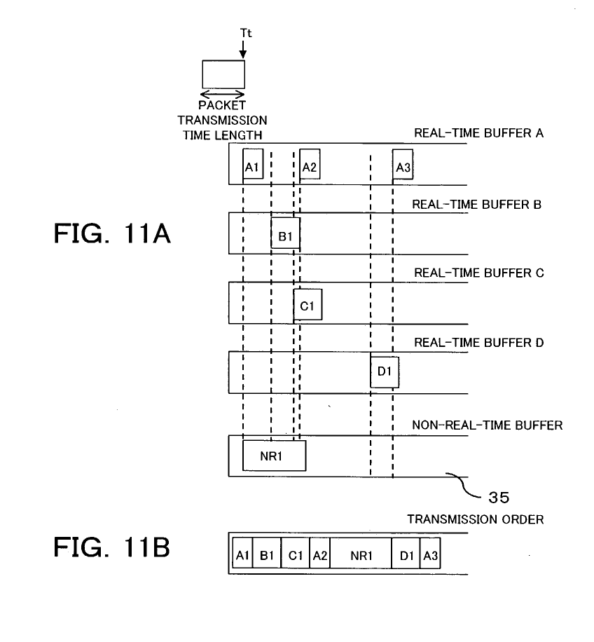

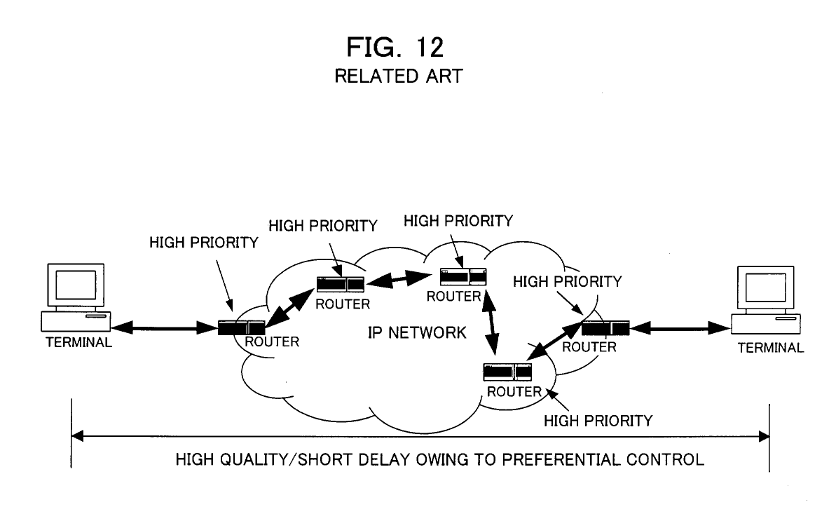

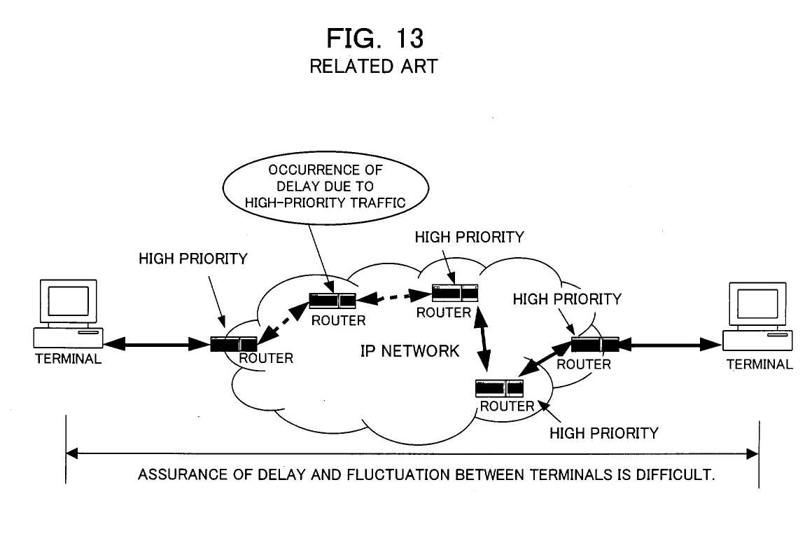

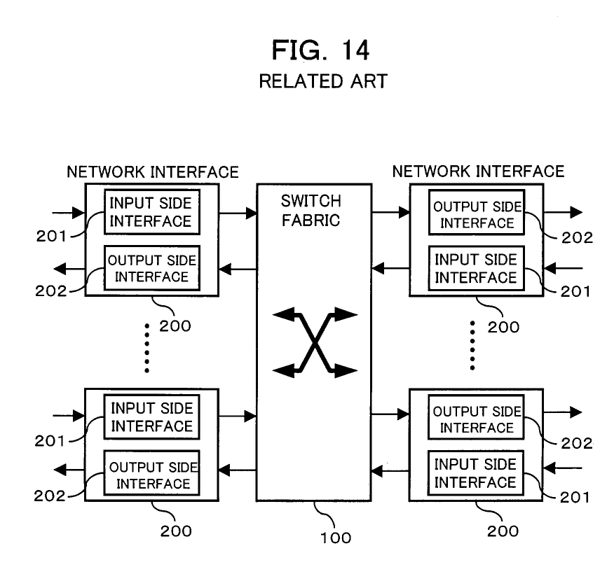

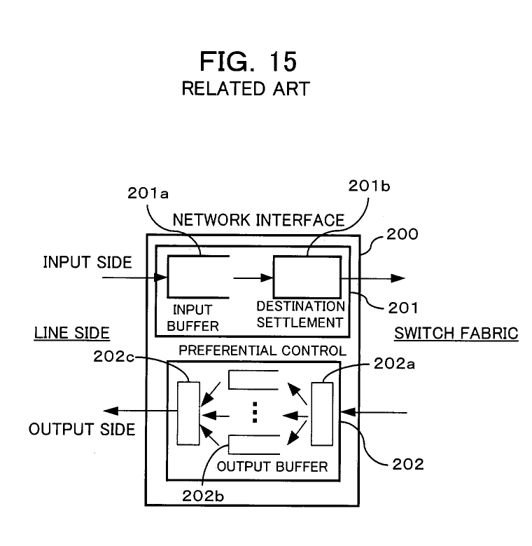

For example, assuming that, as illustratively shown in FIG. 11A, packets A1, A2, A3, a packet B1, a packet C1 and a packet D1 are held in the real-time buffers A, B, C and D, respectively, and a packet NR1 is held in the non-real-time buffer 35, the packets A1 to A3, B1, C1, D1 and NRZ1 are read out and send out in the order of the packet A1→the packet B1→the packet C1→the packet A2→the packet NRZ1→the packet D1→the packet A3 as illustratively shown in FIG. 11B.

As described above, according to this embodiment, in the node 11 constituting the IP network 1, since a real-time packet having a shorter left time length from the arrival time TO before the maximum delay assurance time Te is transferred more preferentially, the maximum value of the packet transfer delay occurring in the node 11 is assurable. As a result, the terminals 2 and 3 can adaptively determine and optimize the buffering quantity of a received packet, and can cope with the degradation of the communication quality stemming from the delay quantity or fluctuation in the communication between the terminals 2 and 3 even in the large-scale IP network, thus enabling securing the necessary communication quality (QoS), particularly, improving the communication quality requiring the real-time processing.

Others

It should be understood that the present invention is not limited to the above-described embodiment, and that it is intended to cover all changes and modifications of the embodiment of the invention herein which do not constitute departures from the spirit and scope of the invention.

For example, in the above-described embodiment, although, at the negotiation, both of the desired output time and the maximum delay assurance time are notified to the destination terminal 2 or 3, it is also appropriate that only one of them is notified thereto.

In addition, each of the nodes 11, although the destination settlement time length and the switching time length are fixedly set in calculating the maximum delay assurance time Te, naturally, these times can also be measured in real time.

Still additionally, in the description of the above-described embodiment, the present invention has been applied to the communication between the terminals 2 and 3 serving as packet communication apparatus, the invention is also applicable to the communication between arbitrary nodes 11 (for example, between edge nodes) in the IP network.

What is claimed is:

1. A communication quality assuring method for use in a packet communication system including a plurality of packet communication apparatus, said method comprising the steps of:
when a communication is established on a packet transfer path, notifying information on delay time of packet transfer, assurable with respect to a received packet quantity by one or more packet communication apparatus existing on said packet transfer path, to a destination side packet communication apparatus; and
making said destination side packet communication apparatus determine a received packet buffering quantity in a communication using said packet transfer path between said destination side packet communication apparatus and an origination side packet communication apparatus on the basis of the notified delay time information.

2. A packet communication apparatus with a transfer delay assurance function, which is a component of a packet communication system, comprising:
a timer for providing time information;
a transmission buffer unit for buffering a received packet;
a monitor unit for monitoring a length of left time from an arrival time of said received packet before a delay assurance time by which transmission processing of said received packet is to be completed, on the basis of said time information provided by said timer; and
a buffering control unit for controlling the buffering of said received packet into said transmission buffer unit on the basis of a result of the monitoring by said monitor unit so that a received packet having a shorter length of left time is transmitted more preferentially.

3. A packet communication apparatus with a transfer delay assurance function according to claim 2, wherein
said monitor unit includes delay assurance time calculating means for calculating said delay assurance time on the basis of information on a transmission packet quantity from an origination side packet communication apparatus, notified in advance from a destination side packet communication apparatus.

4. A packet communication apparatus with a transfer delay assurance function according to claim 3, wherein said transmission buffer unit includes:
a preferential control buffer for storing a received packet undergoing preferential transmission control according to the left time length monitored by said monitor unit; and
a non-preferential control buffer for storing a received packet undergoing transmission control independent of the left time length monitored by said monitor unit, and
said buffering control unit includes:
buffer readout decision means for making a decision, on the basis of information on a packet size of said received packet stored in said non-preferential control buffer and the left time length for said received packet stored in said preferential control buffer, as to whether or not said received packet stored in said preferential control buffer is readable before the end of the left time length in a case in which said received packet stored in said non-preferential control buffer is read out therefrom; and
determining means for determining, as being read out, said received packet stored in said non-preferential control buffer when the decision in said buffer readout decision means shows that said received packet stored in said preferential control buffer is readable before the end of the left time length.

5. A packet communication apparatus with a transfer delay assurance function according to claim 4, wherein said transmission buffer unit includes:
an urgent output buffer for storing a received packet required to be urgently outputted, which has a left time length shorter than a predetermined time length, with the left time length being monitored by said monitor unit, and
said buffering control unit includes:
urgent output control means for, when a received packet exists in said urgent output buffer, reading out said received packet from said urgent output buffer as a first priority.

6. A packet communication apparatus with a transfer delay assurance function according to claim 5, further comprising delay assurance time notifying means for notifying said delay assurance time to said destination side packet communication apparatus.

7. A packet communication apparatus with a transfer delay assurance function according to claim 3, wherein
said transmission buffer unit includes:
an urgent output buffer for storing a received packet required to be urgently outputted, which has a left time length shorter than a predetermined time length, with the left time length being monitored by said monitor unit, and
said buffering control unit includes:
urgent output control means for, when a received packet exists in said urgent output buffer, reading out said received packet from said urgent output buffer as a first priority.

8. A packet communication apparatus with a transfer delay assurance function according to claim 7, further comprising delay assurance time notifying means for notifying said delay assurance time to said destination side packet communication apparatus.

9. A packet communication apparatus with a transfer delay assurance function according to claim 3, further comprising delay assurance time notifying means for notifying said delay assurance time to said destination side packet communication apparatus.

10. A packet communication apparatus with a transfer delay assurance function according to claim 2, wherein said transmission buffer unit includes:
a preferential control buffer for storing a received packet undergoing preferential transmission control according to the left time length monitored by said monitor unit; and
a non-preferential control buffer for storing a received packet undergoing transmission control independent of the left time length monitored by said monitor unit, and said buffering control unit includes:
buffer readout decision means for making a decision, on the basis of information on a packet size of said received packet stored in said non-preferential control buffer and the left time length for said received packet stored in said preferential control buffer, as to whether or not said received packet stored in said preferential control buffer is readable before the end of the left time length in a case in which said received packet stored in said non-preferential control buffer is read out therefrom; and
determining means for determining, as being read out, said received packet stored in said non-preferential control buffer when the decision in said buffer readout decision means shows that said received packet stored in said preferential control buffer is readable before the end of the left time length.

11. A packet communication apparatus with a transfer delay assurance function according to claim 10, wherein said transmission buffer unit includes:
an urgent output buffer for storing a received packet required to be urgently outputted, which has a left time length shorter than a predetermined time length, with the left time length being monitored by said monitor unit, and
said buffering control unit includes:
urgent output control means for, when a received packet exists in said urgent output buffer, reading out said received packet from said urgent output buffer as a first priority.

12. A packet communication apparatus with a transfer delay assurance function according to claim 11, further comprising delay assurance time notifying means for notifying said delay assurance time to said destination side packet communication apparatus.

13. A packet communication apparatus with a transfer delay assurance function according to claim 10, further comprising delay assurance time notifying means for notifying said delay assurance time to said destination side packet communication apparatus.

14. A packet communication apparatus with a transfer delay assurance function according to claim 2, wherein said transmission buffer unit includes:
an urgent output buffer for storing a received packet required to be urgently outputted, which has a left time length shorter than a predetermined time length, with the left time length being monitored by said monitor unit, and
said buffering control unit includes:
urgent output control means for, when a received packet exists in said urgent output buffer, reading out said received packet from said urgent output buffer as a first priority.

15. A packet communication apparatus with a transfer delay assurance function according to claim 14, further comprising delay assurance time notifying means for notifying said delay assurance time to said destination side packet communication apparatus.

16. A packet communication apparatus with a transfer delay assurance function according to claim 2, further comprising delay assurance time notifying means for notifying said delay assurance time to said destination side packet communication apparatus.
